(19) United States
(12) Patent Application Publication
(10) Pub. No.: US 2008/0172742 A1
(43) Pub. Date: Jul. 17, 2008

(54) INFORMATION PROCESSING SYSTEM

(75) Inventor: Seiichi Inoue, Kanagawa (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Infrontia Corporation, Kawasaki-shi (JP)

(21) Appl. No.: 11/871,545

(22) Filed: Oct. 12, 2007

(30) Foreign Application Priority Data
Oct. 13, 2006 (JP) 2006-279922

(51) Int. Cl. G06F 21/00

(52) U.S. Cl. 726/24

(57) ABSTRACT

A system having a client (24) and a server (21) between which two virtual LAN systems are set for normal application and emergency application is disclosed. The server transmits pattern information of a harmful program to the client through the normal virtual LAN (S11). The client monitors intrusion of the harmful program based on the pattern information (S21), and upon detection of the harmful program, switches the virtual LAN from normal to emergency applications (S22). The client transmits infection information about the harmful program to the server through the emergency virtual LAN (S23). The server that has received the infection information transmits an extermination program for the harmful program to the client (S12). The client, upon recognition that the harmful program is invalidated by executing the extermination program, switches the virtual LAN from emergency to normal applications (S26).

This application is based upon and claims the benefit of priority from Japanese patent application No. 2006-279922, filed on Oct. 13, 2006, the disclosure of which is incorporated herein in its entirety by reference.

### BACKGROUND OF THE INVENTION

1. Field of the Invention

This invention relates to a technique for exterminating a harmful program such as a virus or a worm that has intruded into a computer of an information processing system, or in particular to a technique for a computer connected to an intranet such an in-house network.

2. Description of the Related Art

A computer connected to the internet is liable to be infected by a harmful program such as a virus or a worm. Currently, the computer in an intranet of a business or the like has an increasingly high probability of being infected by a harmful program. This is caused by the fact that a harmful program such a virus or worm is sometimes attached to the connection from the intranet to an arbitrary home page on the internet or a mail from an external mobile terminal.

A network manager, upon detection of a intrusion of a harmful program in the intranet, first (1) identifies a terminal that has been infected by the harmful program, (2) isolates the infected terminal from the intranet to prevent a spread of the infection, and (3) exterminates the harmful program for the terminal thus isolated. Upon complete extermination of the harmful program thereafter, the manager restores the terminal to the intranet.

The work described above is required to exterminate a harmful program. The manager of the intranet having a multiplicity of terminals such as an in-house network, therefore, is required to consume a great amount of time and labor to exterminate a virus or the like.

Various techniques have been proposed to exterminate a harmful program that has intruded into the computer. With regard to (1) and (2) described above, for example, as disclosed in JP-A-2003-174483, JP-A-2003-281003, JP-A-2004-348292, JP-A-2004-362012, JP-A-2004-94290, JP-A-2005-157421, JP-A-2005-321897, a technique is available to cut off a network or limit packets automatically upon detection of a virus. Especially for (1) above, a technique has been proposed to attach an infection notification function described in JP-A-2004-246759 to a terminal. Also, as far as (3) is concerned, JP-A-2003-241987, JP-A-2004-234045, JP-A-2005-258514 disclose a technique whereby the manager or the like distributes an extermination tool manually.

### SUMMARY OF THE INVENTION

In the prior art described above, however, manual work is required at a given time point from a detection of the infection of a virus or worm to complete extermination thereof. As a result, a problem is posed that the whole processing time is difficult to shorten and so is to reduce the human labor.

This invention has been achieved in view of the problem described above and the object thereof is to provide a technique to quickly cope with a generation of a harmful program such as a virus or a worm in an intranet.

According to this invention, there is provided an information processing system comprising, a client device and a server device between which two virtual LAN systems are set for normal application and emergency application, wherein the server device includes: a pattern distribution unit transmitting pattern information for identifying a harmful program to the client device through the virtual LAN for normal application; and an extermination tool distribution unit transmitting an extermination program for invalidating the harmful program, through the virtual LAN for emergency application, to the client device which has transmitted infection information indicating a detection of the harmful program to the server device, and the client device includes: an infection monitor unit determining whether the harmful program is in the client device based on the pattern information from the server device, a virtual LAN switching unit switching connection to the server device from the virtual LAN for normal application to the virtual LAN for emergency application upon detection of the harmful program and switching connection to the server device from the virtual LAN for emergency application to the virtual LAN for normal application upon recognition of invalidation of the harmful program by executing the extermination program received from the server device, and an infection notification unit transmitting infection information about the harmful program to the server device upon detection of the harmful program.

According to this invention, even in the case where a harmful program is detected from the client device, the client device can be isolated from and restored to the normal virtual LAN and the harmful program in the client device can be invalidated automatically. As a result, manual work is not necessary for extermination of the harmful program, thereby reducing time, labor and likes for extermination of the harmful program.

### BRIEF DESCRIPTION OF DRAWINGS

FIG. 1 is a block diagram showing the configuration according to a first embodiment of the invention;

FIG. 2 is a block diagram showing the functional configuration according to an embodiment;

FIG. 3 is a flowchart showing the operation steps according to the first embodiment;

FIG. 4 is a block diagram showing the configuration according to a modification of the first embodiment;

FIG. 5 is a block diagram showing the configuration according to a second embodiment of the invention; and

FIG. 6 is a flowchart showing the operation steps according to the second embodiment.

### DESCRIPTION OF THE PREFERRED EMBODIMENT

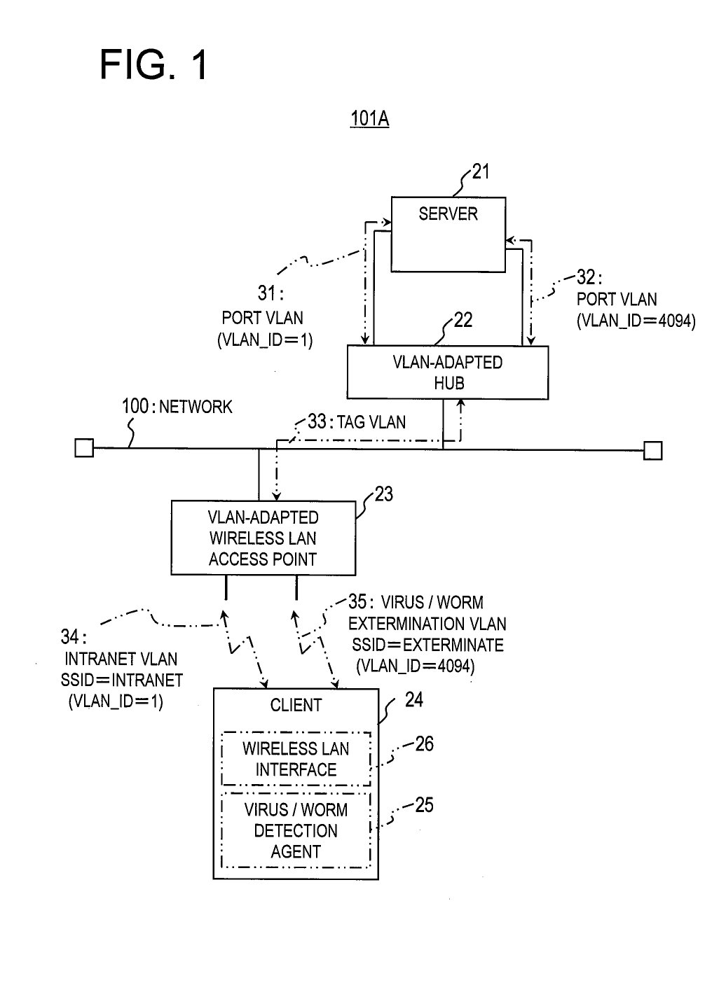

FIG. 1 shows a configuration according to a first embodiment of the invention. A system 101A according to this embodiment is included in an intranet of a business or the like. As shown in FIG. 1, the system 101A includes a client 24 making up a computer used by employees or the like and a server 21 making up a computer for coping with an intrusion of a harmful program such as a virus or a worm into the client 24. The client 24 is installed with a virus/worm detection agent 25 described later, constituting a program for monitoring and exterminating a harmful program.

The client 24 according to this embodiment is a mobile terminal having a wireless LAN interface 26 in charge of wireless LAN communication. The client 24 is connected to a network 100 of the intranet through a wireless LAN access point 23. The server 21 is connected to the network 100 through a hub 22.

Although one each of the servers 21 and the clients 23 is shown in FIG. 1 for simplification, a plurality of them can be arranged by being connected to the wireless LAN access point 23 and the hub 22, respectively, in practical applications.

The server 21 and the client 24 of the system 101A have set therein two virtual LAN systems (hereinafter referred to as “VLAN”) for normal and emergency applications. The VLAN, as known in the prior art, is a technique whereby communication is conducted by assigning a logical LAN to a plurality of computers (21, 24) connected to a physical LAN (100). In VLAN communication, the ID information is added to the communication data to identify each VLAN. Even in the case where a plurality of VLANs share a wired or a wireless physical network, therefore, each VLAN can be handled independently by the ID information.

With regard to the ID information of VLAN, “VLAN ID=1” is set for normal one of the two VLAN systems, and “VLAN ID=4094” for emergency one to exterminate a virus/worm.

At the wireless LAN access point 23, the intranet VLAN 34 corresponding to the normal “VLAN ID=1” with SSID (Service Set Identifiers) as “Intranet” and the virus/worm extermination VLAN 35 corresponding to the emergency “VLAN ID=4094” with SSID as “Exterminate” are handled by a single radio channel. The client 24, when using the intranet VLAN 34, sets “SSID=Intranet” in the radio signal sent to the wireless LAN access point 23. When using the virus/worm extermination VLAN 35, on the other hand, the client 24 sets “SSID=Exterminate” in the radio signal. By this setting, the client 24 switches between the intranet VLAN 34 and the virus/worm extermination VLAN 35 without changing the radio frequency or the modulation scheme.

The wireless LAN access point 23 and the hub 22 are connected physically by the network 100 on the one hand and logically by a tag VLAN 33 in tag VLAN form on the other hand. Between these two units 23 and 22, the data with normal “VLAN ID=1” added thereto and the data with the emergency “VLAN ID=4094” added thereto are exchanged.

The server 21 has two wired LAN interfaces, which are connected to “VLAN ID=1” making up the intranet VLAN port of the hub 22 and “VLAN ID=4094” making up the virus/work extermination VLAN port, respectively. Specifically, the server 21 and the hub 22 are connected logically to two VLAN systems in port VLAN form, i.e. the normal port VLAN 31 with “VLAN ID=1” and the emergency port VLAN 32 with “VLAN ID=4094”.

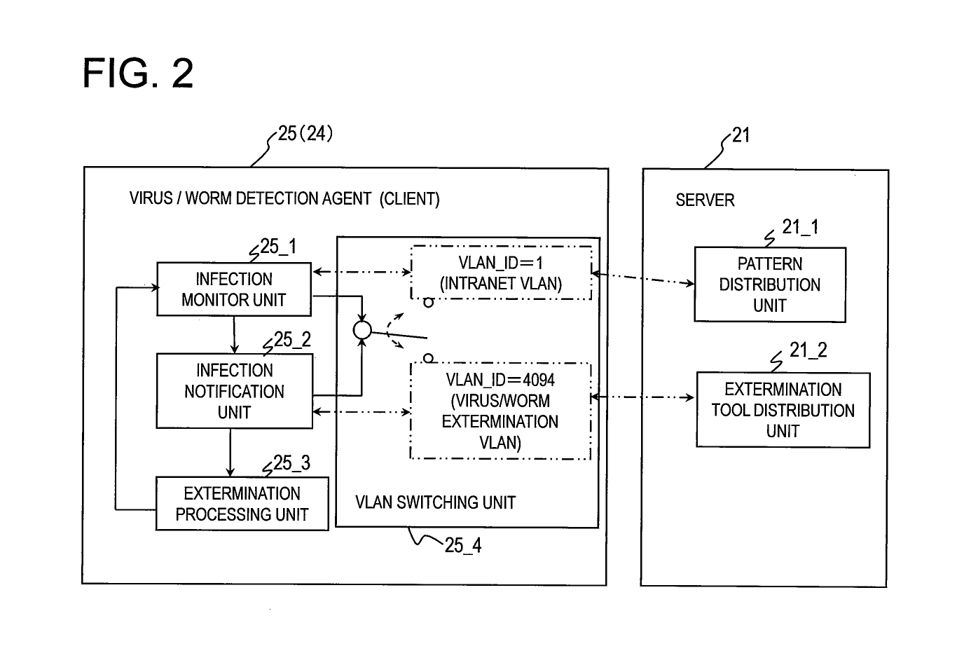

FIG. 2 schematically shows a functional configuration of the virus/worm detection agent 25 of the client 24 and the server 21. The server 21 includes a pattern distribution unit 21_1 for distributing a pattern file for identifying a virus or a worm to the client 24, and an extermination tool distribution unit 21_2 for distributing an extermination tool making up a program for exterminating the harmful program detected by the client 24. The pattern distribution unit 21_1 distributes the latest pattern file to the client 24 through the normal port VLAN 31. The extermination tool distribution unit 21_2 distributes the extermination tool through the emergency port VLAN 32.

The virus/worm detection agent 25, as shown in FIG. 2, includes an infection monitor unit 25_1, an infection notification unit 25_2, an extermination processing unit 25_3 and a VLAN switching unit 25_4. The infection monitor unit 25_1, based on the pattern file received by the normal intranet VLAN 34 (FIG. 1), monitors whether the local device (24) has been infected or not by a harmful program such as a virus or a worm. The VLAN switching unit 25_4, upon detection of an infection, switches the connection to the server 21 from the intranet VLAN 34 to the emergency virus/worm extermination VLAN 35. Also, the VLAN switching unit 25_4, upon successful extermination of the harmful program, restores the connection to the intranet VLAN 34. The infection notification unit 25_2, upon detection of an infection, transmits an infection report describing the specifics of the infection to the server 21. The extermination processing unit 25_3, by executing the extermination tool acquired from the server 21, tries to invalidate the harmful program.

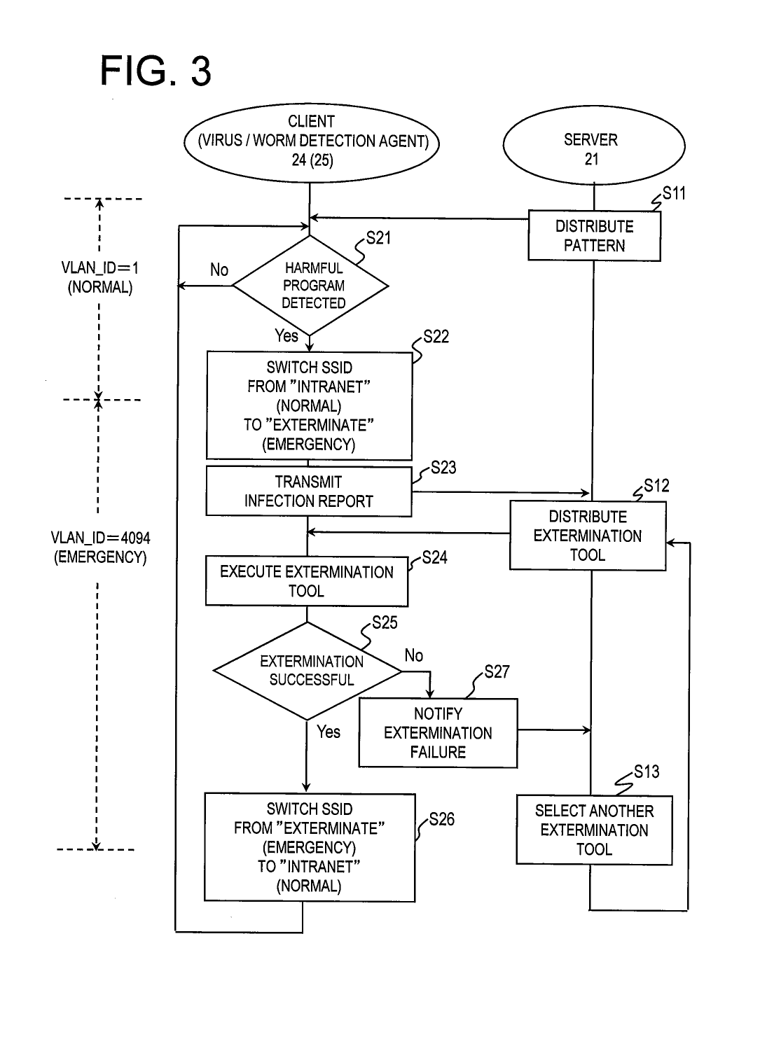

With reference to the flowchart of FIG. 3 and FIG. 1, the operation of the system 101A is explained. The server 21 distributes the latest pattern file to the client 24 through the normal port VLAN 31 (step S11). The pattern file thus distributed is delivered to the client 24 by the intranet VLAN 34 from the wireless LAN access point 23 through the tag VLAN 33 between the hub 22 and the wireless LAN access point 23.

The client 24, based on the pattern file from the server 21, monitors whether a harmful program such as a virus or a worm intrudes into the client 24 (step S21). The client 24, upon detection that the local device has been infected by the harmful program, changes the SSID setting in the radio signal from “Intranet” to “Exterminate” (step S22). As a result, the VLAN used by the client 24 is switched forcibly from the intranet VLAN 34 to the virus/worm extermination VLAN 35. At the same time, the client 24 is automatically isolated from the normal VLAN (“VLAN ID=1”).

The client 24 transmits the infection report describing that a harmful program has been detected by the virus/worm extermination VLAN 35 switched (step S23). The infection report thus transmitted is delivered to the server 21 from the hub 22 by the emergency port VLAN 32 through the tag VLAN 33 between the wireless LAN access point 23 and the hub 22.

The server 21, upon receipt of the infection report, logs the contents thereof. The server 21 selects the extermination tool corresponding to the virus or worm currently notified and sends it to the port VLAN 32 (step S12). The extermination tool thus sent out is delivered to the client 24 from the wireless LAN access point 23 by the virus/worm extermination VLAN 35 through the tag VLAN 33.

The client 24, upon receipt of the extermination tool from the server 21, executes it and thus tries to invalidate the harmful program (step S24). In the process, the extermination processing unit 25_3 (FIG. 2) executes the program of the extermination tool. Upon complete execution of the extermination tool, the infection monitor unit 25_1 (FIG. 2) determines whether a harmful program such as a virus or a worm intrudes into the client 24.

In the case where no harmful program is detected, i.e. a harmful program has been successfully exterminated (YES in step S25), the VLAN switching unit 25_4 changes the wireless LAN SSID from “Exterminate” to “Intranet”. As a result, the VLAN is restored from the work extermination VLAN 35 to the normal intranet VLAN 34 (step S26). The infection monitor unit 25_1 resumes the monitoring of a harmful program (step S21).

In the case where a harmful program is detected again in spite of the execution of the extermination tool, i.e. in the case where the extermination process fails (NO in step S25), on the other hand, the fact is notified to the server 21 by the infection notification unit 25_2 (step S27). The server 21, upon receipt of the notification that the extermination process has failed, selects another extermination tool corresponding to the harmful program involved and transmits it to the client 24 (step S13).

The client 24 continues to acquire a new extermination tool from the server 21 a preset maximum number of times until the harmful program is successfully exterminated. As a result, the harmful program can be completely exterminated. Once the harmful program is successfully exterminated (YES in step S25), the client 24 restores VLAN to the normal intranet VLAN 34 (step S26) and resumes the monitor operation (step S21).

As described above, with the system 101A according to this embodiment, the client 24, even if infected by a harmful program such as a virus or a worm, can be isolated from or restored to the normal VLAN and a harmful program in the client 24 can be exterminated automatically by the virus/worm detection agent 25. As a result, the manual work which otherwise might be required for exterminating a harmful program is eliminated, and therefore, the time and personnel expense for the extermination of a harmful program can be reduced.

As long as the existing intranet is adapted for VLAN, the security in the intranet can be easily improved without introducing a new network device or the network wiring work by constructing the system 101A in the particular intranet.

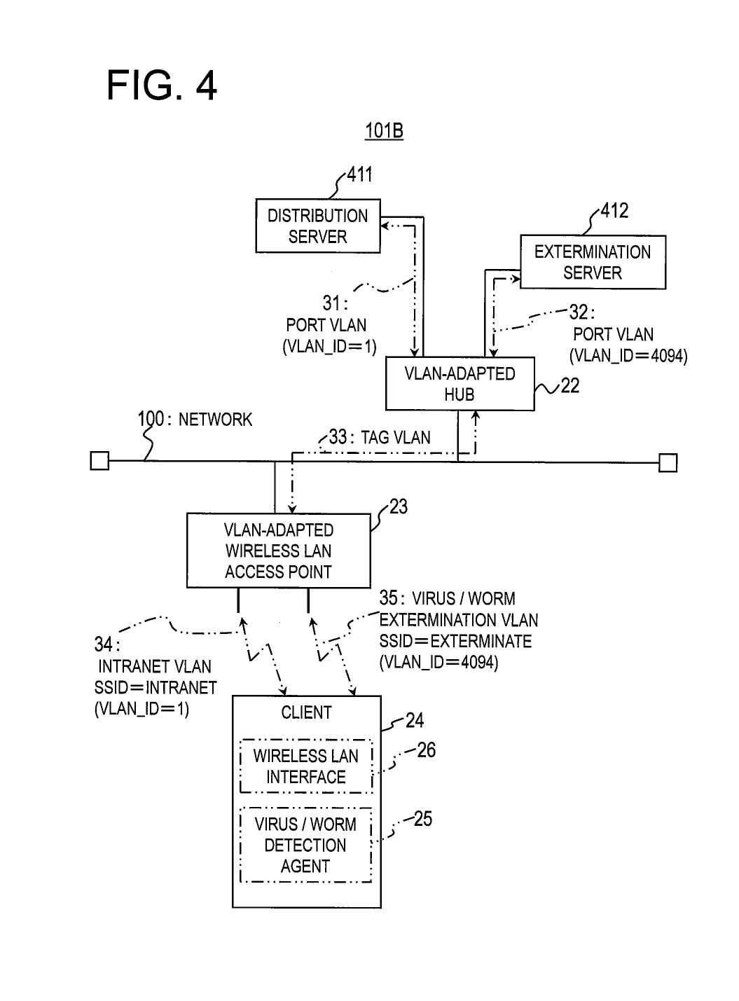

The system 101A, as shown in FIG. 1, is so configured that the pattern file and the extermination tool are distributed by a single server device (21). As an alternative to this configuration, the server device may be divided into two parts physically for separate distribution of the pattern file and the extermination tool. An example of such a system configuration is shown in FIG. 4.

In the system 101B shown in FIG. 4, a distribution server 411 for distributing the pattern file and an extermination server 412 for distributing the extermination tool are connected to the hub 22 in place of the server 21 shown in FIG. 1. The function of the distribution server 411 corresponds to that of the pattern distribution unit 21_1 (FIG. 2) described above, and the function of the extermination server 412 corresponds to that of the extermination tool distribution unit 21_2.

In the system 101B, the distribution server 411 and the extermination server 412 are assigned different physical addresses (MAC addresses), respectively. As shown in FIG. 4, the normal port VLAN 31 (“VLAN ID=1”) is set between the distribution server 411 and the hub 22, and the emergency port VLAN 32 (“VLAN ID=4094”) between the extermination server 412 and the hub 22.

The distribution server 411 corresponds to the first server unit according to this invention, and the extermination server 412 is a component element corresponding to the second server unit. This system 101B also produces a similar effect to the system 101A shown in FIG. 1.

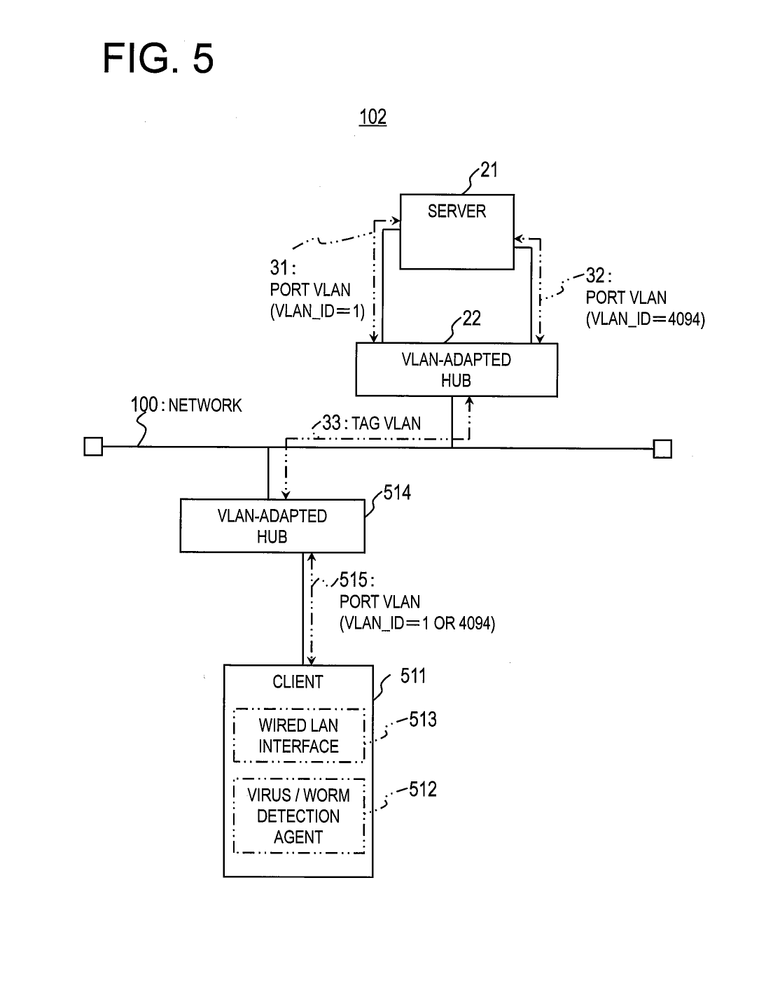

FIG. 5 shows a configuration according to a second embodiment of the invention. According to this embodiment, the client device has a communication form of wired LAN. As shown in FIG. 5, the system 102 according to this embodiment includes a client 511 having a wired LAN interface 513 for connecting to the intranet through a wired LAN and a VLAN-adapted hub 514 for connecting the client 511 to the network 100. The configuration of the other parts of the system 102 is similar to that of the system 101A of FIG. 1 and not described further.

The system 102, like the system 101A described above, has set therein two VLAN systems for normal and emergency applications. Specifically, the VLAN for normal intranet application is assigned “VLAN ID=1” and the VLAN for virus/work extermination “VLAN ID=4094”. The hub 514 is connected to the client 511 by the intranet VLAN port assigned “VLAN ID=1”. The hub 514 conducts communication with the hub 22 of the server 21 through the tag VLAN 33.

The client 511 is installed with a virus/worm detection agent 512 basically having a similar function (FIG. 2) to the virus/worm detection agent 25 described above. The difference between the virus/worm detection agent 512 according to this embodiment and the virus/worm detection agent 25 described above lies in the process of the VLAN switching unit 25_4. The process of the VLAN switching unit 25_4 is explained later.

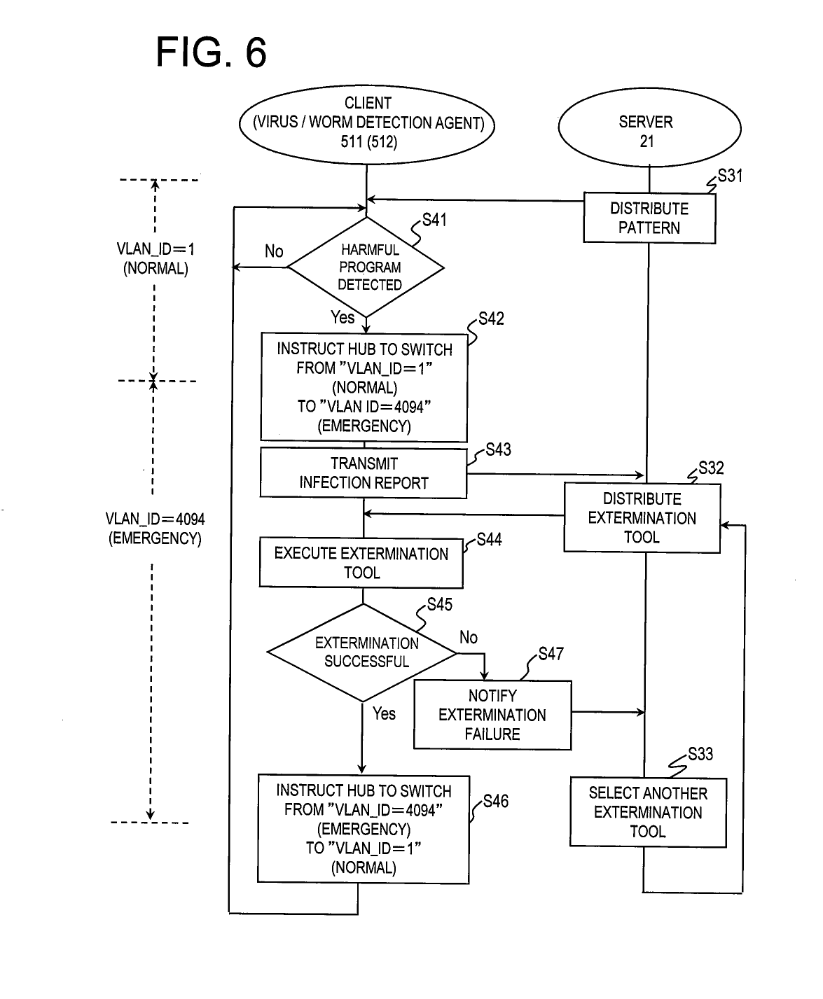

With reference to the flowchart shown in FIG. 6, the operation of the system 102 is explained. The difference between the operation of this system 102 and that of the system 101A described above lies in the process of the VLAN switching unit 25_4 as described above. Therefore, the operation of the VLAN switching unit 25_4 is mainly explained here. The other operation is similar to the one explained above with reference to FIG. 3 and will not be described in detail.

The client 511, based on the latest pattern file distributed from the server 21, monitors whether the local device has been infected by a virus or a worm or not (steps S31, S41).

The client 511, upon detection of the infection by a harmful program during the monitor operation, instructs the hub 514 to change the VLAN ID of the port connected to the client 511 in the hub 514 from normal “1” to “4094” (step S42). In response to this instruction, the VLAN connection of the client 511 is forcibly switched from the normal intranet VLAN to the virus/worm extermination VLAN. Without replacing the LAN cable of the client 511, therefore, the connection for normal and emergency VLAN applications can be automatically switched.

After switching VLAN, the client 511 transmits the infection report to the server 21 and acquires and executes the extermination tool involved (steps S43, S32, S44). In the case where the extermination of the harmful program fails after execution of the extermination tool, the fact is notified to the server 21 and a new extermination tool is acquired (steps S47, S33).

In the case where the extermination of the harmful program ends in success, on the other hand, the client 511 instructs the hub 514 to restore the port VLAN ID from emergency “4094” to normal “1” (step S46). As a result, the client 511 is automatically restored to the intranet VLAN. After that, the client 511 resumes the virus/worm monitor operation (step S41).

According to the second embodiment described above, even in the case where the client device has the communication form of wired LAN, like in the first embodiment described above, a harmful program is exterminated in the client device and the client device is isolated from or restored to the intranet automatically carried out without resorting to the manual work.

The system 102 according to the embodiments described above, a single server 21 distributes the pattern file and the extermination tool. In place of this configuration, the server device may be divided into two parts physically as shown in FIG. 4. Specifically, two servers assigned different physical addresses are prepared, and one of them is operated as a server (411) in charge of the distribution of the pattern file, and the other as a server (412) in charge of the distribution of the extermination tool. As a result, the processing load on the server can be distributed to quickly meet the requirements for prevention of and protection against a harmful program which may be generated.

Although the exemplary embodiments of the present invention have been described in detail, it should be understood that various changes, substitutions and alternatives can be made therein without departing from the sprit and scope of the invention as defined by the appended claims. Further, it is the inventor's intent to retrain all equivalents of the claimed invention even if the claims are amended during prosecution.

What is claimed is:

1. An information processing system comprising,
a client device and a server device between which two virtual LAN systems are set for normal application and emergency application, wherein
the server device includes: a pattern distribution unit transmitting pattern information for identifying a harmful program to the client device through the virtual LAN for normal application; and an extermination tool distribution unit transmitting an extermination program for invalidating the harmful program, through the virtual LAN for emergency application, to the client device which has transmitted infection information indicating a detection of the harmful program to the server device, and
the client device includes: an infection monitor unit determining whether the harmful program is in the client device based on the pattern information from the server device, a virtual LAN switching unit switching connection to the server device from the virtual LAN for normal application to the virtual LAN for emergency application upon detection of the harmful program and switching connection to the server device from the virtual LAN for emergency application to the virtual LAN for normal application upon recognition of invalidation of the harmful program by executing the extermination program received from the server device, and an infection notification unit transmitting infection information about the harmful program to the server device upon detection of the harmful program.

2. The information processing system according to claim 1, wherein
the infection notification unit, upon recognition that the harmful program is not invalidated by executing the extermination program, notifies said situation to the server device, and
the extermination tool distribution unit, upon receipt of the notification about said situation from the infection notification unit, transmits another extermination program for the harmful program to the client device.

3. The information processing system according to claim 1, further comprising a relay device connecting the client device to the two virtual LAN systems through a wireless LAN, wherein
the client device includes a communication interface unit conducting communication with the relay device, and
the virtual LAN switching unit, upon switching connection between the two virtual LAN systems, sets identification information of the wireless LAN on a radio signal transmitted to the relay device in accordance with the virtual LAN system which is selected for said connection.

4. The information processing system according to claim 1, further comprising a relay device connecting the client device to the two virtual LAN systems through a wired LAN, wherein
the client device includes a communication interface unit conducting communication with the relay device, and
the virtual LAN switching unit, upon switching connection between the two virtual LAN systems, requests the relay device to change identification information of the wireless LAN assigned to a connection terminal for the client device in the relay device in accordance with the virtual LAN system which is selected for said connection.

5. The information processing system according to claim 1, wherein
the server device includes a first server unit having the pattern distribution unit and a second server unit assigned a physical address different from that of the first server unit and having the extermination tool distribution unit.

6. A client device having two virtual LAN systems for normal and emergency applications situated between a server unit, comprising:
an infection monitor unit determining whether a harmful program is in the client device based on pattern information for identifying the harmful program;
a virtual LAN switching unit switching connection to the server device from the virtual LAN for normal application to the virtual LAN for emergency application upon detection of a harmful program and switching connection to the server device from the virtual LAN for emergency application to the virtual LAN for normal application upon recognition of invalidation of the harmful program in the client device by executing an extermination program for invalidating the harmful program; and
an infection notification unit transmitting infection information about the harmful program to the server device upon detection of the harmful program.

7. The client device according to claim 6, further comprising a communication interface unit conducting communication with a relay device connecting the client device to the two virtual LAN systems through the wireless LAN, wherein
the virtual LAN switching unit, upon switching connection between the two virtual LAN systems, sets identification information of the wireless LAN on a radio signal transmitted to the relay device in accordance with the virtual LAN system which is selected for said connection.

8. The client device according to claim 6, further comprising a communication interface unit conducting communication with a relay device connecting the client device to the two virtual LAN systems through the wired LAN, wherein
the virtual LAN switching unit, upon switching connection between the two virtual LAN systems, requests the relay device to change identification information of the wireless LAN assigned to a connection terminal for the client device in the relay device in accordance with the virtual LAN system which is selected for said connection.

9. A server device having two virtual LAN systems for normal and emergency applications situated between a client device, comprising:
a pattern distribution unit transmitting pattern information for identifying a harmful program to the client device through the virtual LAN for normal application; and
an extermination tool distribution unit transmitting an extermination program for invalidating the harmful program, through the virtual LAN for emergency application, to the client device which has transmitted infection information indicating a detection of the harmful program to the server device.

10. The server device according to claim 9, wherein the extermination tool distribution unit, upon receipt of a notification from the client device that the harmful program is not invalidated by executing the extermination program, transmits another extermination program for the harmful program to the client device.

11. The server device according to claim 9, comprising a first server unit having the pattern distribution unit and a second server unit assigned a physical address different from that of the first server unit and having the extermination tool distribution unit.
